(19) United States
(12) Patent Application Publication
(10) Pub. No.: US 2024/0212026 A1
(43) Pub. Date: Jun. 27, 2024

(54) DATA PROCESSING METHOD AND APPARATUS, COMPUTER READABLE STORAGE MEDIUM, AND ELECTRONIC DEVICE

(71) Applicant: Beijing Jingdong Zhenshi Information Technology Co., Ltd., Beijing (CN)

(72) Inventor: Hongbo REN, Beijing (CN)

(73) Assignee: Beijing Jingdong Zhenshi Information Technology Co., Ltd., Beijing (CN)

(21) Appl. No.: 18/555,038

(22) PCT Filed: Apr. 13, 2022
(86) PCT No.: PCT/CN2022/086685

§ 371 Date: Oct. 12, 2023

(30) Foreign Application Priority Data
Apr. 15, 2021 (CN) 202110406645.5

(51) Int. Cl. G06Q 30/0601; G06Q 40/10

(52) U.S. Cl. CPC G06Q 30/0635; G06Q 40/10

(57) ABSTRACT

A data processing method and apparatus, a computer readable storage medium, and an electronic device. The method comprises: obtaining a cross-border resource voucher, obtaining a voucher resource corresponding to the cross-border resource voucher, and sending the voucher resource; receiving a resource judgment result corresponding to the voucher resource, and obtaining mode data corresponding to the cross-border resource voucher, wherein an initial value of the mode data is consistent with direct mail mode data; updating the mode data from the direct mail mode data to personal express mail mode data according to the resource judgment result to obtain a target cross-border resource voucher; and sending the target cross-border resource voucher, and receiving a data feedback result corresponding to the target cross-border resource voucher, so as to process the target cross-border resource voucher according to the data feedback result.

The present disclosure is a U.S. National Stage of International Application No. PCT/CN2022/086685, filed on Apr. 13, 2022, which claims priority of Chinese patent application No. 202110406645.4, entitled “data processing method and apparatus, computer readable storage medium, and electronic device”, filed on Apr. 15, 2021 to the CNIPA, the contents of which are hereby incorporated by reference in its entirety.

### TECHNICAL FIELD

The present disclosure relates to the field of computer technology, and in particular, to a data processing method and apparatus, a computer-readable storage medium and an electronic device.

### BACKGROUND

With the development of computer technology, e-commerce has become popular and developed. More and more users can shop online through the Internet, and users include domestic users and foreign users. The domestic users can purchase imported products through the Internet, and the domestic merchants can sell products to foreign users through exporting products.

In related technology, when the products purchased by the user are products that need to be imported or exported, the order corresponding to the products needs to be declared to the General Administration of Customs. During the declaration process, the default declaration mode is usually the direct mail mode. At this time, the General Administration of Customs will determine whether the amount of the order exceeds the total amount. When the amount of the order exceeds the total amount, a customs clearance failure message will be returned, and then the merchant will notify the user to cancel the order.

It should be noted that the information disclosed in the above background section is only used to enhance understanding of the background of the present disclosure, and therefore may include information that does not constitute prior art known to those of ordinary skill in the art.

### SUMMARY

The purpose of this disclosure is to provide a data processing method, apparatus, computer-readable storage medium and electronic device.

Additional features and advantages of the disclosure will be apparent from the following detailed description, or, in part, may be learned by practice of the disclosure.

According to a first aspect of an embodiment of the present disclosure, a data processing method is provided. The method includes: obtaining a cross-border resource voucher and obtaining a voucher resource corresponding to the cross-border resource voucher, and sending the voucher resource; receiving a resource judgment result corresponding to the voucher resource, and obtaining mode data corresponding to the cross-border resource voucher, wherein an initial value of the mode data is consistent with direct mail mode data; updating the mode data from the direct mail mode data to personal express mail mode data according to the resource judgment result, to obtain a target cross-border resource voucher; and sending the target cross-border resource voucher, and receiving a data feedback result corresponding to the target cross-border resource voucher, so as to process the target cross-border resource voucher according to the data feedback result.

In an example embodiment of the present disclosure, updating the mode data from the direct mail mode data to personal express mail mode data according to the resource judgment result includes: obtaining a preset judgment result corresponding to the resource judgment result, updating the mode data from the direct mail mode data to the personal express mail mode data, if the resource judgment result is consistent with the preset judgment result.

In an example embodiment of the present disclosure, updating the mode data from the direct mail mode data to personal express mail mode data includes: obtaining update identification information corresponding to the cross-border resource voucher, and obtaining a plurality of update information corresponding to the update identification information; updating the mode data from the direct mail mode data to the personal express mail mode data, if the update identification information matches one of the plurality of update information.

In an example embodiment of the present disclosure, the update information includes first update information; updating the mode data from the direct mail mode data to the personal express mail mode data, if the update identification information matches one of the plurality of update information includes: updating the mode data in the cross-border resource voucher from the direct mail mode data to the personal express mail mode data, if the update identification information matches the first update information.

In an example embodiment of the present disclosure, the update information includes second update information; updating the mode data from the direct mail mode data to the personal express mail mode data, if the update identification information matches one of the plurality of update information includes: obtaining quantity information corresponding to the cross-border resource voucher, if the update identification information matches the second update information; obtaining a voucher resource threshold and resource corresponding to the cross-border resource voucher, if the quantity information is plural; splitting the cross-border resource voucher into a first cross-border resource voucher and a second cross-border resource voucher according to the voucher resource threshold, if the resource is less than the voucher resource threshold, wherein a first voucher resource corresponding to the first cross-border resource voucher is less than or equal to the voucher resource threshold; maintaining first mode data corresponding to the first cross-border resource voucher as the direct mail mode data, and updating second mode data corresponding to the second cross-border resource voucher from the direct mail mode data to the personal express mail mode data.

In an example embodiment of the present disclosure, splitting the cross-border resource voucher into a first cross-border resource voucher and a second cross-border resource voucher according to the voucher resource threshold includes: calculating the voucher resource threshold according to the quantity information to obtain a threshold calculation result, and splitting the cross-border resource voucher into a first cross-border resource voucher and a second cross-border resource voucher based on the threshold calculation result.

In an example embodiment of the present disclosure, obtaining a voucher resource corresponding to the cross-border resource voucher includes: obtaining a cross-border resource voucher to be verified, and obtaining basic data corresponding to the cross-border resource voucher to be verified; obtaining a basic condition corresponding to the basic data, determining the cross-border resource voucher to be verified corresponding to the basic data as a cross-border resource voucher, if the basic data satisfies the basic condition.

According to a second aspect of an embodiment of the present disclosure, a data processing apparatus is provided. The apparatus includes: an acquisition module, configured to obtain a cross-border resource voucher and obtain a voucher resource corresponding to the cross-border resource voucher, and send the voucher resource; a receiving module, configured to receive a resource judgment result corresponding to the voucher resource, and obtain mode data corresponding to the cross-border resource voucher, wherein an initial value of the mode data is consistent with direct mail mode data; an updating module, configured to update the mode data from the direct mail mode data to personal express mail mode data according to the resource judgment result, to obtain a target cross-border resource voucher; and a processing module, configured to send the target cross-border resource voucher, and receive a data feedback result corresponding to the target cross-border resource voucher, so as to process the target cross-border resource voucher according to the data feedback result.

According to a third aspect of an embodiment of the present disclosure, an electronic device is provided. The electronic device includes: a processor; and a memory for storing instructions executable by the processor; wherein, the processor is configured to perform the data processing method according to any one of above example embodiments via executing the executable instructions.

According to a fourth aspect of an embodiment of the present disclosure, a non-transitory computer-readable storage medium is provided, having a computer program stored thereon, wherein the computer program implements the data processing method according to any one of above example embodiments when executed by a processor.

It should be understood that the foregoing general description and the following detailed description are exemplary and explanatory only, and do not limit the present disclosure.

### BRIEF DESCRIPTION OF THE DRAWINGS

The accompanying drawings, which are incorporated in and constitute a part of this specification, illustrate embodiments consistent with the disclosure and together with the description, serve to explain the principles of the disclosure. The drawings in the following description are only some embodiments of the present disclosure. For those of ordinary skill in the art, other drawings can be obtained based on these drawings without exerting creative efforts.

FIG. 1 schematically shows a flowchart of a data processing method in an embodiment of the present disclosure;

FIG. 2 schematically shows a flowchart of the data processing method before obtaining the voucher resource corresponding to the cross-border resource voucher in the embodiment of the present disclosure;

FIG. 3 schematically shows a flowchart of updating mode data from direct mail mode data to personal express mail mode data by the data processing method in an embodiment of the present disclosure;

FIG. 4 schematically shows a schematic flowchart of a data processing method for updating mode data in an embodiment of the present disclosure;

FIG. 5 schematically shows a flowchart of a data processing method in an application scenario in an embodiment of the present disclosure;

FIG. 6 schematically shows a schematic structural diagram of a data processing apparatus in an embodiment of the present disclosure;

FIG. 7 schematically illustrates an electronic device used for a data processing method in an embodiment of the present disclosure; and

FIG. 8 schematically illustrates a computer-readable storage medium used for a data processing method in an embodiment of the present disclosure.

### DETAILED DESCRIPTION

Example embodiments will now be described more fully with reference to the accompanying drawings. Example embodiments may, however, be embodied in various forms and should not be construed as limited to the examples set forth herein; rather, these embodiments are provided so that this disclosure will be thorough and complete, and will fully convey the concepts of the example embodiments to those skilled in the art. The described features, structures or characteristics may be combined in any suitable manner in one or more embodiments. In the following description, numerous specific details are provided to provide a thorough understanding of embodiments of the disclosure. However, those skilled in the art will appreciate that the technical solutions of the present disclosure may be practiced without one or more of the specific details described, or other methods, components, devices, steps, etc. may be adopted. In other instances, well-known technical solutions have not been shown or described in detail to avoid obscuring aspects of the disclosure.

The terms “a”, “an”, “the” and “said” are used in this specification to indicate the existence of one or more elements/components/etc.; the terms “include” and “have” are used to indicate an open-ended inclusive meaning and means that there may be additional elements/components/etc. in addition to the listed elements/components/etc.; the terms “first” and “second” etc. are used as labels only and do not limit the number of the objects.

Furthermore, the drawings are merely schematic illustrations of the present disclosure and are not necessarily drawn to scale. The same reference numerals in the drawings represent the same or similar parts, and thus their repeated description will be omitted. Some of the block diagrams shown in the figures are functional entities and do not necessarily correspond to physically or logically separate entities.

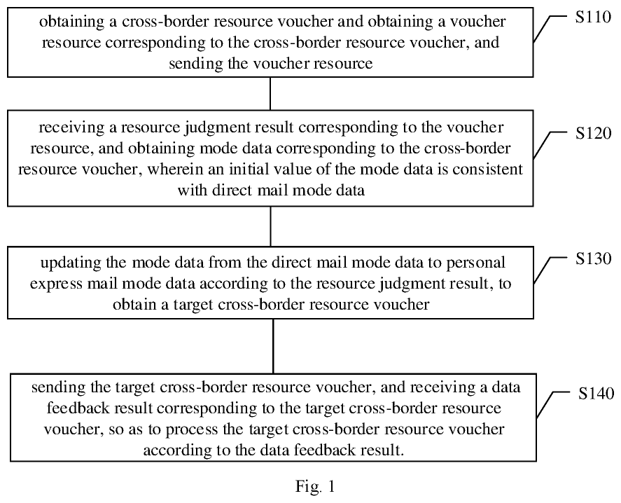

In view of the problems existing in related technologies, this disclosure proposes a data processing method. FIG. 1 shows a schematic flowchart of the data processing method. As shown in FIG. 1, the data processing method at least includes the following steps.

Step S110, a cross-border resource voucher is obtained and a voucher resource corresponding to the cross-border resource voucher is obtained, and the voucher resource is sent.

Step S120, a resource judgment result corresponding to the voucher resource is received, and mode data corresponding to the cross-border resource voucher is obtained, wherein an initial value of the mode data is consistent with direct mail mode data.

Step S130, the mode data is updated from the direct mail mode data to personal express mail mode data according to the resource judgment result, to obtain a target cross-border resource voucher.

Step S140, the target cross-border resource voucher is sent, and a data feedback result corresponding to the target cross-border resource voucher is received, so as to process the target cross-border resource voucher according to the data feedback result.

In the method and apparatus provided by the example embodiments of the present disclosure, the mode data is updated from direct mail mode data to personal express mail mode data according to the resource judgment result, which improves the logic of processing the cross-border resource voucher and improves the efficiency of processing the cross-border resource voucher, thus effectively reducing the inability to process the cross-border resource voucher and improving user experience.

Each step of the data processing method is explained in detail below.

In step S110, a cross-border resource voucher is obtained and a voucher resource corresponding to the cross-border resource voucher is obtained, and the voucher resource is sent.

In the example embodiment of the present disclosure, the cross-border resource voucher refers to the declaration form corresponding to the purchased imported or exported products, and the declaration mode is the direct mail mode for declaration to the General Administration of Customs. Based on this, the cross-border resource voucher can include the name of the purchased product, the order number of the purchased product, the unit price of the purchased product, the total price of all purchased products, the purchaser name of the product, the consignee name of the product, and the product delivery address, the tax rate corresponding to the product, and the declaration mode corresponding to the product and other basic data. It is worth noting that the cross-border resource voucher can include any basic data describing the product, which is not particularly limited by the example embodiment.

The declaration mode refers to the mode used when declaring the cross-border resource voucher to the General Administration of Customs. The Customs refers to the entry and exit customs supervision and management agency of the country. Correspondingly, the General Administration of Customs refers to the General Administration agency of the Customs.

It is worth noting that the declaration mode corresponding to the cross-border resource voucher is the direct mail declaration mode. This is because the transportation fee of the direct mail mode is lower and the corresponding tax rate is also lower. Specifically, the direct mail mode refers to a product delivery manner of purchasing products overseas and sending them to overseas agent collection stations, sending the products to domestic airports by air or sea freight and other logistics manners, and the agent company directly delivering the products after completing relevant procedures at the General Administration of Customs. The advantages of the direct mail mode are lower freight and lower tax rate, and the disadvantage is that there is a limited amount.

In addition, usually in e-commerce, the orders corresponding to the imported or exported products purchased by the user will be split in advance according to the type of products, to generate cross-border resource vouchers. For example, the imported products purchased by the user include cosmetics A, cosmetics B, electronic product C, and pharmaceutical product D. At this time, the imported products purchased by the user will be split, to generate cross-border resource voucher 1, cross-border resource voucher 2 and cross-border resource voucher 3. The cross-border resource voucher 1 corresponds to cosmetics A and cosmetics B, the cross-border resource voucher 2 corresponds to electronic product C, and cross-border resource voucher 3 corresponds to pharmaceutical product D.

Furthermore, the reason for the above splitting is that the country has different requirements for import and export tax rates for different products. Therefore, a cross-border resource voucher declared to the General Administration of Customs needs contain the import and export tax rates corresponding to the product. Therefore, product orders need to be split according to the type of product, and corresponding cross-border resource vouchers are generated. Based on this, the obtained cross-border resource voucher usually corresponds to the same type of products, and the voucher resource corresponding to the cross-border resource voucher refer to the total price of all products corresponding to the cross-border resource vouchers.

For example, cross-border resource voucher A is obtained, and cross-border resource voucher A corresponds to cosmetics 1, cosmetics 2 and cosmetics 3. The total payment required to purchase cosmetics 1, cosmetics 2, and cosmetics 3 is 400RMB, then at this time, the voucher resource is 400, and the voucher resource is sent to the customs electronic port or directly sent to the General Administration of Customs.

The Customs e-port refers to the sub-departments established by the General Administration of Customs in various places, which are used to push cross-border resource vouchers received by various e-commerce platforms to the General Administration of Customs.

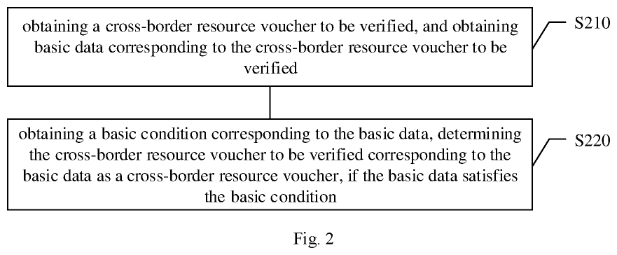

In an optional embodiment, FIG. 2 shows a flowchart of the data processing method before obtaining the voucher resource corresponding to the cross-border resource voucher. As shown in FIG. 2, the method at least includes the following step. In step S210, a cross-border resource voucher to be verified is obtained, and basic data corresponding to the cross-border resource voucher to be verified is obtained.

The cross-border resource voucher to be verified refers to the voucher corresponding to the imported or exported product that needs to be declared to the General Administration of Customs. Based on this, the basic data refers to the data describing the product corresponding to the cross-border voucher resource to be verified. Specifically, the basic data can include the name of the purchased product, the order number of the purchased product, the unit price of the purchased product, the total price of all purchased products, the address of the purchased product, the purchaser name of the product, the consignee name of the product, the shipping address of the product, and the tax rate corresponding to the product, which is not specifically limited in this example embodiment.

For example, the obtained cross-border resource voucher to be verified includes the cross-border resource voucher to be verified being A and the cross-border resource voucher to be verified being B. The purchaser name of the product corresponding to the cross-border resource voucher to be verified A is “Zhang San”, and the consignee name of the product corresponding to the cross-border resource voucher to be verified A is “Zhang San”, the purchaser name of the product corresponding to the cross-border resource voucher to be verified B is “Li Si”, and the consignee name of the product corresponding to the cross-border resource voucher to be verified B is “Li Si”.

In step S220, a basic condition corresponding to the basic data is obtained, the cross-border resource voucher to be verified corresponding to the basic data is determined as a cross-border resource voucher, if the basic data satisfies the basic condition.

The basic condition refers to the condition that the basic data in the voucher corresponding to the direct mail declaration mode required by the General Administration of Customs needs to meet. For example, if the declaration mode of the cross-border resource voucher is required to be the direct mail mode, the basic condition can be a condition that the purchaser name of the product in the basic data must be consistent with the consignee name of the product, and it can also be a condition to determine whether the unit price of the product is zero. It is worth mentioning that the basic condition can be any condition that the basic data of cross-border resource voucher declared in the direct mail mode by customs must meet, which is not particularly limited by the example embodiment.

Furthermore, the reason why it is necessary to judge the basic data in the cross-border resource voucher to be verified is to exclude the voucher that cannot be declared in the direct mail mode from the cross-border resource vouchers to be verified. Based on this, when the basic data meets the basic condition, the cross-border resource voucher corresponding to the basic data is determined to be a cross-border resource voucher.

For example, the obtained cross-border resource vouchers to be verified include the cross-border resource voucher to be verified being A and the cross-border resource voucher to be verified being B. The purchaser name of the product corresponding to the cross-border resource voucher to be verified A is “Zhang San”, and the consignee name of the product corresponding to the cross-border resource voucher to be verified A is “Zhang San”, the purchaser name of the product corresponding to the cross-border resource voucher to be verified B is “Zhang San”, and the consignee name of the product corresponding to the cross-border resource voucher to be verified B is “Li Si”. The obtained basic condition is that the consignee name of the product must be consistent with the purchaser name of the product.

Among the obtained cross-border resource vouchers to be verified, only the cross-border resource voucher to be verified A satisfies the basic condition, and the cross-border resource voucher to be verified A is determined to be a cross-border resource voucher.

In this example embodiment, before determining to obtain the voucher resource, all cross-border resource vouchers to be verified are obtained first, and the basic data in the cross-border resource vouchers to be verified are judged, which improves the logic of determining the voucher resource and avoids the situation where cross-border resource vouchers cannot be declared in the direct mail mode, improves the efficiency of cross-border resource voucher declaration, and thus improves the speed at which users receive products.

In step S120, a resource judgment result corresponding to the voucher resource is received, and mode data corresponding to the cross-border resource voucher is obtained, wherein an initial value of the mode data is consistent with direct mail mode data.

In an example embodiment of the present disclosure, the resource judgment result is a judgment result of whether the voucher resource is greater than the total amount required by the General Administration of Customs. The total amount refers to the amount threshold with respect to different types of products by the General Administration of Customs under the direct mail mode of declaration.

Based on this, there are two resource judgment results. One is that the voucher resource is greater than or equal to the total amount required by the General Administration of Customs, and the other is that the voucher resource is less than the total amount required by the General Administration of Customs.

The mode data refers to data that corresponds to the cross-border resource voucher and represents the cross-border resource voucher declaration mode. Specifically, the mode data can be a number or a character string. This example embodiment does not make any special limitation for this. For example, when the declaration mode is the direct mail mode, the mode data can correspond to the direct mail mode data 1, and when the declaration mode is the personal express mail mode, the declaration data can correspond to the personal express mail mode data 2. The personal express mail mode data refers to the mode data indicating that the declaration mode of cross-border resource voucher is the personal express mail mode. The personal express mail mode refers to a product declaration mode with a higher tax rate and higher freight than the direct mail mode. However, compared with the direct mail mode, the General Administration of Customs requires a high total amount for the personal express mail mode.

For example, the received resource judgment result is that the voucher resource is greater than the total amount required by the General Administration of Customs. The obtained mode data corresponding to the cross-border resource voucher is 1, and the mode data 1 is consistent with the direct mail mode data corresponding to the direct mail mode.

In an example embodiment of the present disclosure, before the General Administration of Customs clears cross-border resource vouchers, the resource judgment results and model data are first obtained, which is helpful for subsequently updating the model data based on the resource judgment results, thereby improving the efficiency of cross-border voucher processing, which effectively reduces the inability to process cross-border resource vouchers, thereby improving user experience.

In step S130, the mode data is updated from the direct mail mode data to personal express mail mode data according to the resource judgment result, to obtain a target cross-border resource voucher.

In an example embodiment of the present disclosure, the target cross-border resource voucher refers to a voucher obtained after updating the mode data in the cross-border resource voucher from the direct mail mode data to the personal express mail mode data.

For example, if the resource judgment result corresponding to a cross-border resource voucher is that the voucher resource is greater than or equal to the total amount required by the General Administration of Customs, the mode data in the cross-border resource voucher can be updated from 1 to 2. That is, the mode data is updated from the direct mail mode data to personal express mail mode data, to obtain a target cross-border resource voucher.

In an optional embodiment, updating the mode data from the direct mail mode data to personal express mail mode data according to the resource judgment result includes: obtaining a preset judgment result corresponding to the resource judgment result, updating the mode data from the direct mail mode data to the personal express mail mode data, if the resource judgment result is consistent with the preset judgment result.

The preset judgment result is the judgment result that the voucher resource is greater than or equal to the total amount required by the General Administration of Customs.

For example, the voucher resource in the cross-border resource voucher A is 6000, the product corresponding to cross-border resource voucher A is cosmetics, the total amount of cross-border resource vouchers required by the General Administration of Customs with the declaration mode being direct mail mode and the product type being cosmetics is 5000. The received resource judgment result sent by the General Administration of Customs at this time is that the voucher resource is greater than the total amount required by the General Administration of Customs. The obtained preset judgment result is that the voucher resource is greater than or equal to the total amount required by the General Administration of Customs.

At this time, the resource judgment result is consistent with the preset judgment result, the mode data in the cross-border resource voucher A is updated from 1 to 2, where 1 is the direct mail mode data corresponding to the direct mail mode, and 2 is the personal express mail mode data corresponding to the personal express mail mode.

In this example embodiment, when the resource judgment result is consistent with the preset judgment result, the mode data is updated from the direct mail mode data to the personal express mail mode data, since the customs has a low total amount limit for the products in the resource voucher whose declaration mode is the personal express mail mode, the logic of processing cross-border resource vouchers is improved, and the efficiency of processing cross-border resource vouchers is improved, thereby effectively reducing the inability to process cross-border resource vouchers and improving user experience.

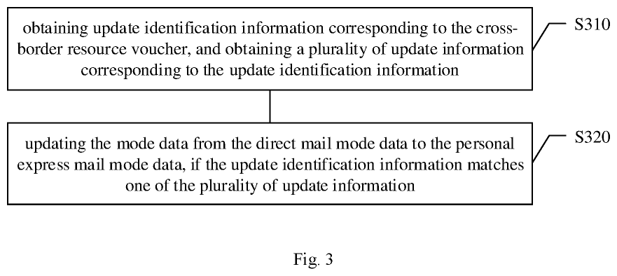

In an optional embodiment, FIG. 3 shows a schematic flowchart of updating mode data from direct mail mode data to personal express mail mode data in the data processing method. As shown in FIG. 3, the method at least includes the following step. In step S310, update identification information corresponding to the cross-border resource voucher is obtained, and a plurality of update information corresponding to the update identification information is obtained.

The update identification information refers to the identification corresponding to the cross-border resource voucher and used to indicate whether the merchant or user agrees to update the mode data when the resource judgment result is consistent with the preset result. The update identification information may be a number or a character string, which is not specifically limited in this example embodiment.

A plurality of update information refers to the information that the merchant or user agrees to update the mode data when the resource judgment result is consistent with the preset result. The plurality of update information can be represented by a number or a character string, which is not specifically limited in this example embodiment.

For example, the update identification information corresponding to the cross-border resource voucher is 1, which specifically indicates that the user agrees to update the mode data information in the first way when the resource judgment result is consistent with the preset result. The obtained plurality of update information includes 1 and 2, where 1 means that the user or merchant agrees to update the mode data information in the first way when the resource judgment result is consistent with the preset result, and 2 means that the user or merchant agrees to update the mode data information in the second way when the resource judgment result is consistent with the preset result. It is worth mentioning that the plurality of update information can also include that the user or merchant agrees to update the mode data information in other ways that are different from the first way and the second way, when the resource judgment result is consistent with the preset result, which is not specifically limited in this example embodiment.

In step S320, the mode data is updated from the direct mail mode data to the personal express mail mode data, if the update identification information matches one of the plurality of update information.

If the update identification information matches one of the plurality of update information, the mode data is updated from the direct mail mode data to the personal express mail mode data.

For example, if the plurality of update information includes 1 and 2, and the update identification information is 0, where 1 indicates that the user or merchant agrees to update the mode data information in the first way when the resource judgment result is consistent with the preset result, 2 indicates that the user or the merchant agrees to update the model data information in the second way when the resource judgment result is consistent with the preset result, 0 indicates that neither the merchant nor the user agrees to update the model data when the resource judgment result is consistent with the preset result. At this time, the update identification information does not match the plurality of update information, the mode data cannot be updated, and the mode data still corresponds to the direct mail mode data.

For example, if the plurality of update information includes 1 and 2, and the update identification information is 1, where 1 indicates that the user or merchant agrees to update the mode data information in the first way when the resource judgment result is consistent with the preset result, 2 indicates that the user or merchant agrees to update the mode data information in the second way when the resource judgment result is consistent with the preset result. At this time, if the update identification information matches one of the plurality of update information, the mode data will be updated, and the mode data is updated from the initial value to the personal express mail mode data.

In this example embodiment, by determining whether the update identification information matches one of the plurality of update information, not only the manner of updating the mode data can be determined, but also customer complaints can be avoided, which improves the efficiency of cross-border resource voucher processing.

In an optional embodiment, the update information includes first update information; updating the mode data from the direct mail mode data to the personal express mail mode data, if the update identification information matches one of the plurality of update information includes: updating the mode data in the cross-border resource voucher from the direct mail mode data to the personal express mail mode data, if the update identification information matches the first update information.

The first update information is one of the plurality of update information. If the update identification information matches the first update information, the mode data corresponding to the cross-border resource voucher is directly updated from the direct mail mode data to the personal express mail mode data. The first update information may be a number or a character string, which is not specifically limited in this example embodiment.

For example, the first update information is 1, and 1 indicates that the merchant or user agrees to update the mode data information in the first way when the resource judgment result is consistent with the preset result. If the update identification information at this time is also 1, the update identification information matches the first update information, then the mode data in the target cross-border resource voucher is updated from 1 to 2, where 1 is the direct mail mode data and 2 is the personal express mail mode data.

In this example embodiment, when the update identification information matches the first update information, the mode data corresponding to the cross-border resource voucher is directly updated from the direct mail mode data to the personal express mail mode data, which improves the logic of processing the cross-border resource voucher and improves the efficiency of processing the cross-border resource voucher, thus effectively reducing the inability to process the cross-border resource voucher and improving user experience.

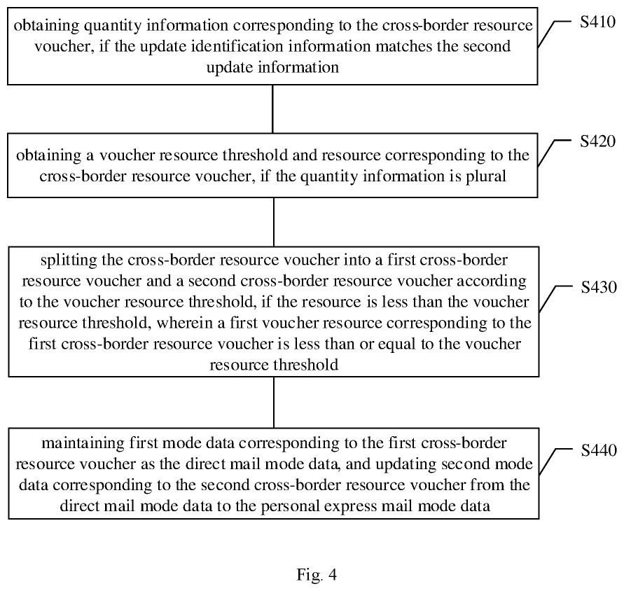

In an optional embodiment, FIG. 4 shows a schematic flowchart of updating mode data if the update identification information matches one of the plurality of update information in the data processing method. As shown in FIG. 4, the update information includes the second update information, the method at least includes the following step. In step S410, quantity information corresponding to the cross-border resource voucher is obtained, if the update identification information matches the second update information.

The second update information is one of the plurality of update information. If the update identification information matches the second update information, the cross-border resource voucher will be split into two cross-border resource vouchers, and the mode data of only one of the cross-border resource vouchers is updated from the direct mail mode data to the personal express mail mode data.

Quantity information refers to information corresponding to the cross-border resource voucher and indicating the quantity of purchased products.

For example, the update identification information is 2, and the second update identification information is 2. At this time, the update identification information matches the second update information, and the number of products corresponding to the cross-border resource voucher is obtained as 2.

In step S420, a voucher resource threshold and resource corresponding to the cross-border resource voucher are obtained, if the quantity information is plural.

The voucher resource threshold is the total amount that the products corresponding to cross-border resources can reach when the declaration mode is direct mail mode specified by the General Administration of Customs.

The resource refers to the unit price of the product corresponding to the cross-border resource voucher.

For example, if the number of products corresponding to the cross-border resource voucher is 2, there are a plurality of data information at this time. The voucher resource threshold corresponding to the cross-border resource voucher is obtained as 5000, and the unit price of the product corresponding to the cross-border resource voucher is 3,000, i.e., the resource is 3,000.

In step S430, the cross-border resource voucher is split into a first cross-border resource voucher and a second cross-border resource voucher according to the voucher resource threshold, if the resource is less than the voucher resource threshold, wherein a first voucher resource corresponding to the first cross-border resource voucher is less than or equal to the voucher resource threshold.

After splitting the cross-border resource voucher, two cross-border resource vouchers will be obtained, one of which can be the first cross-border resource voucher and the other can be the second cross-border resource voucher. The first voucher resource refers to the voucher resource corresponding to the first cross-border resource voucher, i.e., the total amount of products corresponding to the first cross-border resource voucher, and its total amount of the products needs to be less than or equal to the voucher resource threshold.

For example, it is assumed that the voucher resource of the cross-border resource voucher is 6,000, that is, the total amount of product A purchased by the user corresponding to the cross-border resource voucher is 6000 yuan, and the quantity information is 2. That is, the total quantity of product A corresponding to the cross-border resource voucher is 2, and the resource is 3000, that is, the unit price of product A corresponding to the cross-border resource voucher is 3000, and the voucher resource threshold is 5000. Based on this, the cross-border resource voucher can be divided into the first and second cross-border resource voucher based on the resource voucher threshold, and the first voucher resource corresponding to the first cross-border resource voucher must be less than the voucher resource threshold 5000.

Specifically, the first cross-border resource voucher can be a cross-border resource voucher that contains one product A and is used for declaration to the General Administration of Customs. The second cross-border resource voucher can be a cross-border resource voucher that contains another product A and is used for declaration to the General Administration of Customs.

In step S440, first mode data corresponding to the first cross-border resource voucher is maintained as the direct mail mode data, and second mode data corresponding to the second cross-border resource voucher is updated from the direct mail mode data to the personal express mail mode data.

The first mode data refers to the mode data corresponding to the first cross-border resource voucher, and correspondingly, the second mode data refers to the mode data corresponding to the second cross-border resource voucher.

Since the first voucher resource corresponding to the first cross-border resource voucher is definitely less than or equal to the voucher resource threshold, the first cross-border resource voucher can still be declared to the General Administration of Customs in the direct mail declaration mode. Based on this, first mode data corresponding to the first cross-border resource voucher is maintained as the direct mail mode data, and second mode data corresponding to the second cross-border resource voucher is updated from the direct mail mode data to the personal express mail mode data.

In this example embodiment, since the tax rate for declaring the cross-border resource voucher in the direct mail mode is lower than the tax rate for declaring the cross-border resource voucher in the personal express mail mode, and the freight rate for declaration in the direct mail mode is lower than the freight rate for declaration in the personal express mail mode, the completion degree of the cross-border resource vouchers can be improved if the cross-border resource vouchers are divided, thereby improving the completion efficiency of the cross-border resource voucher, and also improving the experience of users and merchants.

In an optional embodiment, dividing the cross-border resource voucher into a first cross-border resource voucher and a second cross-border resource voucher according to the voucher resource threshold includes: calculating the voucher resource threshold according to the quantity information to obtain a threshold calculation result, and dividing the cross-border resource voucher into a first cross-border resource voucher and a second cross-border resource voucher based on the threshold calculation result.

The threshold calculation result refers to the result of calculating the voucher resource threshold based on the quantity information.

For example, there are three products A in the cross-border resource voucher, and the resources corresponding to the cross-border resource voucher, i.e., the unit price of product A is 2,500 yuan, and the voucher resource threshold is 5,000 yuan.

Based on this, there are two methods for splitting cross-border resource vouchers. The first method is to determine that the first cross-border resource voucher includes two products A, the second cross-border resource voucher includes one product A. The second method is to determine that the first cross-border resource voucher includes one product A, and the second cross-border resource includes two products A.

In order to determine the method of splitting cross-border resource vouchers, it is necessary to calculate the voucher resource threshold based on quantity information. Specifically, the threshold calculation result obtained by calculating the voucher resource threshold and quantity information is 2500. If the resource, i.e., the unit price of the products corresponding to the cross-border resource vouchers is less than or equal to 2,500, the above first splitting method is used to split the cross-border resource vouchers. If the resource is greater than 2,500, the above second method is used to split the cross-border resource vouchers.

In this example embodiment, splitting the cross-border resource vouchers based on the threshold calculation result can improve the completion degree of the cross-border resource vouchers, improve the completion efficiency of the cross-border resource vouchers, and reduce the transportation fee that users need to pay when purchasing products, thereby improving the experience of users and merchants.

In step S140, the target cross-border resource voucher is sent, and a data feedback result corresponding to the target cross-border resource voucher is received, so as to process the target cross-border resource voucher according to the data feedback result.

In the example embodiment of the present disclosure, the data feedback result refers to the data used by the General Administration of Customs to determine whether to release the products declared in the target cross-border resource voucher after receiving the target cross-border resource voucher. The data feedback result may be a number or a character string, which is not specifically limited in this example embodiment.

For example, if the target cross-border resource voucher A is sent to the General Administration of Customs and the sent data feedback result 1 is received from the General Administration of Customs, that is, the General Administration of Customs agrees to allow the product corresponding to the target cross-border resource voucher A to enter the country. The logistics information corresponding to the target cross-border resource voucher A is updated based on the data feedback result.

If the received data feedback result is 0, that is, the General Administration of Customs does not agree to allow the product corresponding to the target cross-border resource voucher A to enter the country. At this time, the data feedback result can be sent to the merchant corresponding to the target cross-border resource voucher A. The merchant informs the user that the purchase of the product corresponding to the target cross-border resource voucher A has failed.

In the example embodiment of the present disclosure, the data feedback result corresponding to the target cross-border resource voucher is obtained, and the target cross-border resource voucher is processed according to the data feedback result, which improves the efficiency of processing the cross-border resource voucher, and further effectively reduces the inability to process the cross-border resource voucher and improves user experience.

In the method and apparatus provided by the example embodiments of the present disclosure, the mode data is updated from the direct mail mode data to the personal express mail mode data according to the resource judgment result, which improves the logic of processing the cross-border resource voucher and improves the efficiency of processing the cross-border resource voucher, thus effectively reducing the inability to process the cross-border resource voucher and improving user experience.

The data processing method in the embodiment of the present disclosure will be described in detail below in conjunction with an application scenario.

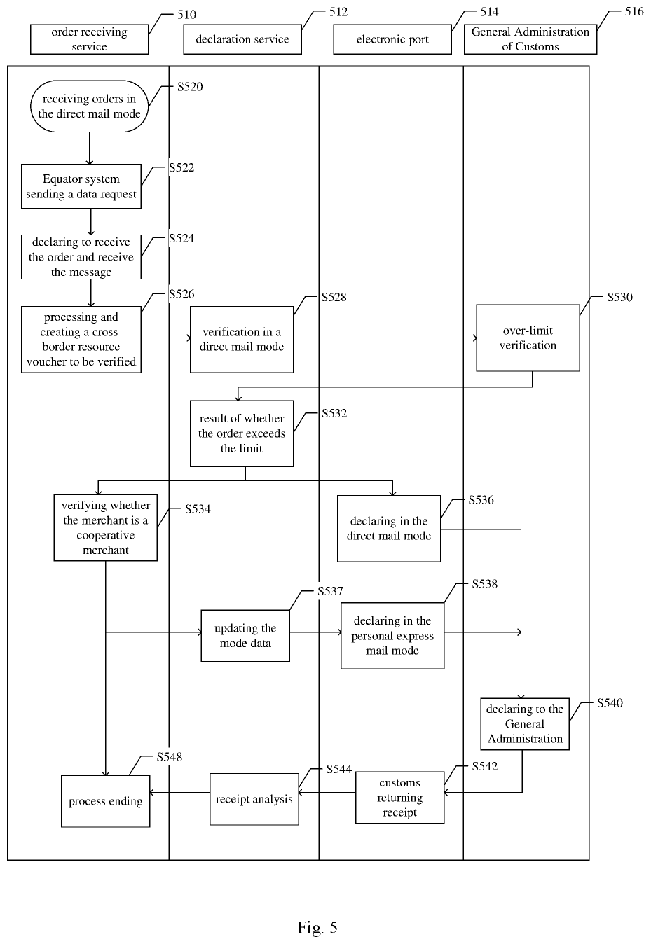

FIG. 5 shows a schematic flowchart of the data processing method in the application scenario, in which 510 is the order receiving service, 512 is the declaration service, 514 is the electronic port, and 516 is the General Administration of Customs.

Specifically, in the order receiving service 510, step S520 is first executed to receive orders in the direct mail mode, that is, the product order is received in the direct mail mode. Then step S522 is executed, the Equator system sends a data request. Then step S524 is executed to declare to receive the order and receive the message, that is, the message corresponding to the data request sent by the Equator System is received. Then step S526 is executed to process the message to create a cross-border resource voucher to be verified, and then enter step S528 for verification in a direct mail mode of the declaration service 512. That is, the basic data corresponding to the cross-border resource voucher to be verified is obtained and the basic condition corresponding to the basic data is obtained, and it is determined whether the basic data meets the basic condition.

If the judgment result in step S528 is that the basic data satisfies the judgment basic condition, the cross-border resource voucher to be verified corresponding to the basic data is determined to be a cross-border resource voucher whose declaration mode is the direct mail mode.

After executing S528, step S530 of over-limit verification in the General Administration of Customs 516 will be executed. That is, it is judged whether the voucher resource is greater than the voucher resource threshold, and the result of the judgment, that is, the resource judgment result will be returned to step S532 in the declaration service 512.

If the result of whether the order exceeds the limit (i.e., the resource judgment result) in step S532 is that the voucher resource is less than the voucher resource threshold, step S536 is executed to declare to the electronic port 514 in the direct mail mode. After receiving the cross-border resource voucher, the electronic port sends the cross-border resource voucher to General Administration of Customs 516, then General Administration of Customs 516 executes step S540 to declare to the General Administration, to obtain the customs return receipt result, and send the customs return receipt result to the electronic port 514. The step S542, customs return receipt, that is, the electronic port receives the customs return receipt result, and then the receipt analysis S544 in the declaration service 512 will analyze the customs receipt result and send the analysis result to the step process end S548 of the order receiving service 510. Specifically, step S548 will process the cross-border resource voucher based on the analysis result and then end the process.

If the resource judgment result received in step S532 is that the voucher resource is greater than or equal to the voucher resource threshold, step S534 is executed to verify whether the merchant is a cooperative merchant, that is, it is determined whether the update identification information is one of the update information. If yes, step S537 is executed to update the mode data. That is, the mode data in the cross-border resource voucher is updated from the direct mail mode data to the personal express mail mode data, and then step S538 is executed to declare in the personal express mail mode. That is, it is declared to the electronic port 514 in the personal express mail mode, and steps S540, S542, S544 and S548 are executed subsequently.

If the verification result in step S534 is that the update identification information does not belong to one type of update information, step S548 is directly executed.

In this application scenario, the mode data is updated from direct mail mode data to personal express mail mode data according to the resource judgment result, which improves the logic of processing the cross-border resource voucher and improves the efficiency of processing the cross-border resource voucher, thus effectively reducing the inability to process the cross-border resource voucher and improving user experience.

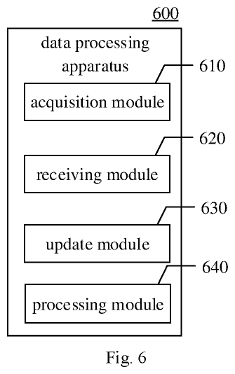

Furthermore, in an example embodiment of the present disclosure, a data processing apparatus is also provided. FIG. 6 shows a schematic structural diagram of a data processing apparatus. As shown in FIG. 6, the data processing apparatus 600 may include: an acquisition module 610, a receiving module 620, an update module 630 and a processing module 640.

An acquisition module 610 is configured to obtain a cross-border resource voucher and obtain a voucher resource corresponding to the cross-border resource voucher, and send the voucher resource. A receiving module 620 is configured to receive a resource judgment result corresponding to the voucher resource, and obtain mode data corresponding to the cross-border resource voucher, wherein an initial value of the mode data is consistent with direct mail mode data. An updating module 630 is configured to update the mode data from the direct mail mode data to personal express mail mode data according to the resource judgment result, to obtain a target cross-border resource voucher. A processing module 640 is configured to send the target cross-border resource voucher, and receive a data feedback result corresponding to the target cross-border resource voucher, so as to process the target cross-border resource voucher according to the data feedback result.

The specific details of the above data processing apparatus 600 have been described in detail in the corresponding data processing method, so they will not be described again here.

It should be noted that although several modules or units of the data processing apparatus 600 are mentioned in the above detailed description, this division is not mandatory. In fact, according to embodiments of the present disclosure, the features and functions of two or more modules or units described above may be embodied in one module or unit. Conversely, the features and functions of one module or unit described above may be further divided into being embodied by a plurality of modules or units.

Furthermore, in an example embodiment of the present disclosure, an electronic device capable of implementing the above method is also provided.

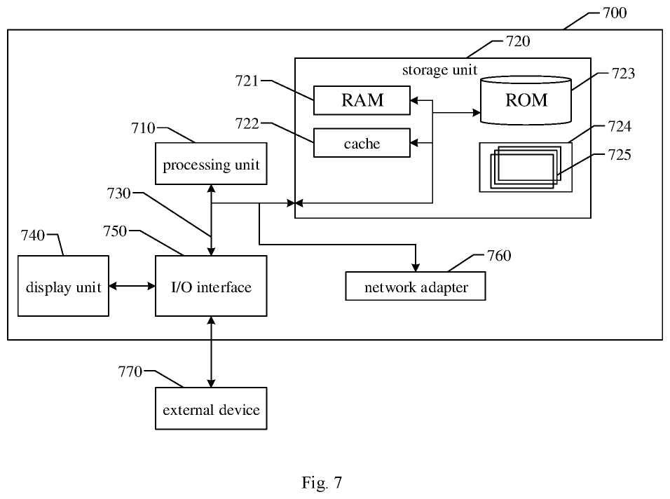

An electronic device 700 according to such an embodiment of the disclosure is described below with reference to FIG. 7. The electronic device 700 shown in FIG. 7 is only an example and should not impose any limitations on the functions and usage scope of the embodiments of the present disclosure.

As shown in FIG. 7, the electronic device 700 is embodied in the form of a general computing device. The components of the electronic device 700 may include, but are not limited to: the above at least one processing unit 710, the above at least one storage unit 720, a bus 730 connecting different system components (including the storage unit 720 and the processing unit 710), and the display unit 740.

The storage unit stores a program code, and the program code can be executed by the processing unit 710, so that the processing unit 710 performs steps in various example embodiments according to the present disclosure described in the “Exemplary Method” section of this specification.

The storage unit 720 may include a readable medium in the form of a volatile storage unit, such as a random access storage unit (RAM) 721 and/or a cache storage unit 722, and may further include a read-only storage unit (ROM) 723.

The storage unit 720 may also include a program/usage tool 724 having a set of (at least one) program modules 725 including, but not limited to: an operating system, one or more application programs, other program modules, and program data. Each of these examples, or some combination, may contain the realities of network environment.

The bus 730 may be a local area bus representing one or more of several types of bus structures, including a memory unit bus or memory unit controller, a peripheral bus, a graphics acceleration port, a processing unit, or using any of a variety of bus structures.

The electronic device 700 may also communicate with one or more external devices 770 (e.g., keyboard, pointing device, Bluetooth device, etc.), may also communicate with one or more devices that enable a user to interact with the electronic device 700, and/or with any device (e.g., router, modem, etc.) that enables the electronic device 700 to communicate with one or more other computing devices. This communication may occur through the input/output (I/O) interface 750. Furthermore, the electronic device 700 may also communicate with one or more networks (e.g., a local area network (LAN), a wide area network (WAN), and/or a public network, such as the Internet) through the network adapter 760. As shown, the network adapter 760 communicates with other modules of the electronic device 700 via the bus 730. It should be understood that, although not shown in the figures, other hardware and/or software modules may be used in conjunction with the electronic device 700, including but not limited to: microcode, device drivers, redundant processing units, external disk drive arrays, RAID systems, tape drives and data backup storage system, etc.

Through the description of the above embodiments, those skilled in the art can easily understand that the example embodiments described here can be implemented by software, or can be implemented by software combined with necessary hardware. Therefore, the technical solution according to the embodiment of the present disclosure can be embodied in the form of a software product, and the software product can be stored in a non-volatile storage medium (which can be a CD-ROM, U disk, mobile hard disk, etc.) or on the network, including several instructions to cause a computing device (which may be a personal computer, a server, a terminal device, a network device, etc.) to execute a method according to an embodiment of the present disclosure.

In an example embodiment of the present disclosure, a computer-readable storage medium is also provided, on which a program product capable of implementing the method described above in this specification is stored. In some possible embodiments, various aspects of the present disclosure can also be implemented in the form of a program product, which includes program code. When the program product is run on a terminal device, the program code is used to cause the terminal device to perform the steps according to various example embodiments of the present disclosure described in the “Exemplary Method” section above in this specification.

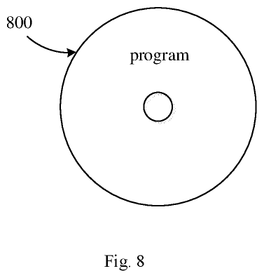

Referring to FIG. 8, a program product 800 for implementing the above method according to an embodiment of the present disclosure is described, which can adopt a portable compact disk read-only memory (CD-ROM) and include program code, and can be run on a terminal device, for example, a personal computer. However, the program product of the present disclosure is not limited thereto. In this document, a readable storage medium may be any tangible medium containing or storing a program that may be used by or in combination with an instruction execution system, apparatus or device.

The program product may take the form of any combination of one or more readable media. The readable medium may be a readable signal medium or a readable storage medium. The readable storage medium may be, for example, but not limited to, an electrical, magnetic, optical, electromagnetic, infrared, or semiconductor system, apparatus or device, or any combination thereof. More specific examples (non-exhaustive list) of readable storage media include: electrical connection with one or more conductors, portable disk, hard disk, random access memory (RAM), read only memory (ROM), erasable programmable read-only memory (EPROM or flash memory), optical fiber, portable compact disk read-only memory (CD-ROM), optical storage device, magnetic storage device, or any suitable combination of the above.

A computer-readable signal medium may include a data signal propagated in baseband or as part of a carrier wave carrying readable program codes therein. Such propagated data signals may take many forms, including but not limited to electromagnetic signals, optical signals, or any suitable combination of the above. A readable signal medium may also be any readable medium other than a readable storage medium, that can send, propagate, or transport the program for use by or in connection with an instruction execution system, apparatus, or device.

Program codes contained on a readable medium may be transmitted using any suitable medium, including but not limited to wireless, wired, optical cable, RF, etc., or any suitable combination of the foregoing.

Program codes for performing the operations of the present disclosure may be written in any combination of one or more programming languages, including object-oriented programming languages such as Java, C++, etc., as well as conventional procedural programming language—such as “C” or a similar programming language. The program codes may execute entirely on the user's computing device, partly on the user's device, as a stand-alone software package, partly on the user's computing device and partly on a remote computing device, or entirely on the remote computing device or server. In situations involving remote computing devices, the remote computing device may be connected to the user computing device through any kind of network, including a local area network (LAN) or a wide area network (WAN), or may be connected to an external computing device, such as provided by an Internet service provider to connect via the Internet.

Other embodiments of the disclosure will be readily apparent to those skilled in the art from consideration of the specification and practice of the disclosure disclosed herein. This disclosure is intended to cover any variations, uses, or adaptations of the disclosure that follow the general principles of the disclosure and include common knowledge or customary technical means in the technical field that are not disclosed in the disclosure. The specification and examples are considered as exemplary only, with a true scope and spirit of the disclosure being indicated by the following claims.

1. A data processing method, comprising:
obtaining a cross-border resource voucher and obtaining a voucher resource corresponding to the cross-border resource voucher, and sending the voucher resource:
receiving a resource judgment result corresponding to the voucher resource, and obtaining mode data corresponding to the cross-border resource voucher, wherein an initial value of the mode data is consistent with direct mail mode data:
updating the mode data from the direct mail mode data to personal express mail mode data according to the resource judgment result, to obtain a target cross-border resource voucher; and
sending the target cross-border resource voucher, and receiving a data feedback result corresponding to the target cross-border resource voucher, so as to process the target cross-border resource voucher according to the data feedback result.

2. The data processing method according to claim 1, wherein updating the mode data from the direct mail mode data to personal express mail mode data according to the resource judgment result comprises:
obtaining a preset judgment result corresponding to the resource judgment result, updating the mode data from the direct mail mode data to the personal express mail mode data, in response to determining that the resource judgment result is consistent with the preset judgment result.

3. The data processing method according to claim 2, wherein updating the mode data from the direct mail mode data to personal express mail mode data comprises:
obtaining update identification information corresponding to the cross-border resource voucher, and obtaining a plurality of update information corresponding to the update identification information;
updating the mode data from the direct mail mode data to the personal express mail mode data, in response to determining that the update identification information matches one of the plurality of update information.

4. The data processing method according to claim 3, wherein the update information comprises first update information;
updating the mode data from the direct mail mode data to the personal express mail mode data, in response to determining that the update identification information matches one of the plurality of update information comprising:
updating the mode data in the cross-border resource voucher from the direct mail mode data to the personal express mail mode data, in response to determining that the update identification information matches the first update information.

5. The data processing method according to claim 3, wherein the update information comprises second update information;
updating the mode data from the direct mail mode data to the personal express mail mode data, in response to determining that the update identification information matches one of the plurality of update information comprising:
obtaining quantity information corresponding to the cross-border resource voucher, in response to determining that the update identification information matches the second update information;
obtaining a voucher resource threshold and resource corresponding to the cross-border resource voucher, in response to determining that the quantity information is plural;
splitting the cross-border resource voucher into a first cross-border resource voucher and a second cross-border resource voucher according to the voucher resource threshold, in response to determining that the resource is less than the voucher resource threshold, wherein a first voucher resource corresponding to the first cross-border resource voucher is less than or equal to the voucher resource threshold;
maintaining first mode data corresponding to the first cross-border resource voucher as the direct mail mode data, and updating second mode data corresponding to the second cross-border resource voucher from the direct mail mode data to the personal express mail mode data.

6. The data processing method according to claim 5, wherein splitting the cross-border resource voucher into a first cross-border resource voucher and a second cross-border resource voucher according to the voucher resource threshold comprises:
calculating the voucher resource threshold according to the quantity information to obtain a threshold calculation result, and splitting the cross-border resource voucher into a first cross-border resource voucher and a second cross-border resource voucher based on the threshold calculation result.

7. The data processing method according to claim 1, wherein obtaining a voucher resource corresponding to the cross-border resource voucher comprises:
obtaining a cross-border resource voucher to be verified, and obtaining basic data corresponding to the cross-border resource voucher to be verified;
obtaining a basic condition corresponding to the basic data, determining the cross-border resource voucher to be verified corresponding to the basic data as a cross-border resource voucher, in response to determining that the basic data satisfies the basic condition.

8. A data processing apparatus, comprising:
a processor; and
a memory for storing instructions executable by the processor;
wherein, the processor is configured to:
obtain a cross-border resource voucher and obtain a voucher resource corresponding to the cross-border resource voucher, and send the voucher resource;
receive a resource judgment result corresponding to the voucher resource, and obtain mode data corresponding to the cross-border resource voucher, wherein an initial value of the mode data is consistent with direct mail mode data:
update the mode data from the direct mail mode data to personal express mail mode data according to the resource judgment result, to obtain a target cross-border resource voucher; and
send the target cross-border resource voucher, and receive a data feedback result corresponding to the target cross-border resource voucher, so as to process the target cross-border resource voucher according to the data feedback result.

9. (canceled)

10. A non-transitory computer-readable storage medium, having a computer program stored thereon, wherein the computer program implements a data processing method when executed by a processor, wherein the data processing method comprises:
obtaining a cross-border resource voucher and obtaining a voucher resource corresponding to the cross-border resource voucher, and sending the voucher resource;
receiving a resource judgment result corresponding to the voucher resource, and obtaining mode data corresponding to the cross-border resource voucher, wherein an initial value of the mode data is consistent with direct mail mode data;
updating the mode data from the direct mail mode data to personal express mail mode data according to the resource judgment result, to obtain a target cross-border resource voucher; and
sending the target cross-border resource voucher, and receiving a data feedback result corresponding to the target cross-border resource voucher, so as to process the target cross-border resource voucher according to the data feedback result.

11. The data processing apparatus according to claim 8, wherein the processor is further configured to:
obtain a preset judgment result corresponding to the resource judgment result, updating the mode data from the direct mail mode data to the personal express mail mode data, in response to determining that the resource judgment result is consistent with the preset judgment result.

12. The data processing apparatus according to claim 11, wherein the processor is further configured to:
obtain update identification information corresponding to the cross-border resource voucher, and obtain a plurality of update information corresponding to the update identification information;
update the mode data from the direct mail mode data to the personal express mail mode data, in response to determining that the update identification information matches one of the plurality of update information.

13. The data processing apparatus according to claim 12, wherein the update information comprises first update information;
wherein the processor is further configured to:
update the mode data in the cross-border resource voucher from the direct mail mode data to the personal express mail mode data, in response to determining that the update identification information matches the first update information.

14. The data processing apparatus according to claim 12, wherein the update information comprises second update information;
wherein the processor is further configured to:
obtain quantity information corresponding to the cross-border resource voucher, in response to determining that the update identification information matches the second update information;
obtain a voucher resource threshold and resource corresponding to the cross-border resource voucher, in response to determining that the quantity information is plural;
split the cross-border resource voucher into a first cross-border resource voucher and a second cross-border resource voucher according to the voucher resource threshold, in response to determining that the resource is less than the voucher resource threshold, wherein a first voucher resource corresponding to the first cross-border resource voucher is less than or equal to the voucher resource threshold;
maintain first mode data corresponding to the first cross-border resource voucher as the direct mail mode data, and updating second mode data corresponding to the second cross-border resource voucher from the direct mail mode data to the personal express mail mode data.

15. The data processing apparatus according to claim 14, wherein the processor is further configured to:
calculate the voucher resource threshold according to the quantity information to obtain a threshold calculation result, and split the cross-border resource voucher into a first cross-border resource voucher and a second cross-border resource voucher based on the threshold calculation result.

16. The data processing apparatus according to claim 8, wherein the processor is further configured to:
obtain a cross-border resource voucher to be verified, and obtain basic data corresponding to the cross-border resource voucher to be verified;
obtain a basic condition corresponding to the basic data, determine the cross-border resource voucher to be verified corresponding to the basic data as a cross-border resource voucher, in response to determining that the basic data satisfies the basic condition.
